(19) United States
(12) Patent Application Publication
(10) Pub. No.: US 2016/0089695 A1
(43) Pub. Date: Mar. 31, 2016

(54) BONDABLE FLUORINATED BARRIER COATINGS

(71) Applicant: U.S. Army Research Laboratory ATTN: RDRL-LOC-I, Adelphi, MD (US)

(72) Inventors: Victor Rodriguez-Santiago, Lutherville, MD (US); Joseph P. Labukas, Nottingham, PA (US)

(73) Assignee: UNITED STATES GOVERNMENT AS REPRESENTED BY THE SECRETARY OF THE ARMY

(21) Appl. No.: 14/496,039

(22) Filed: Sep. 25, 2014

(51) Int. Cl. B05D 5/00; B05D 7/00; B05D 3/06

(52) U.S. Cl. CPC B05D 5/00; B05D 3/068; B05D 7/00

(57) ABSTRACT

Bondable fluorinated barrier coatings on oxidized metal surfaces. The barrier coatings include a perfluorinated silane having a C2-C30 alkyl chain with a reactive silicon end containing 1 to 3 leaving groups. The perfluorinated silane layer is covalently bonded to an underlying oxide layer and the outer surface is treated with an atmospheric-pressure plasma treatment. The resultant barrier coating exhibits corrosion resistance attributed to perfluorinated silanes but with enhanced bonding/adhesion properties.

### GOVERNMENT INTEREST

The invention described herein may be manufactured, used, and licensed by or for the United States Government.

### FIELD OF THE INVENTION

The present invention relates in general to fluorinated barrier coatings, and in particular to bondable fluorinated barrier coatings on oxidized metal surfaces that exhibit excellent bonding properties to a top coating.

### BACKGROUND OF THE INVENTION

The use of anodically grown oxide layers on metallic components is known. For example, current state-of-the art practices anodically oxidize alloy components in order to provide enhanced corrosion resistance. It is also known that such anodically grown oxide layers can be brittle and/or have small cracks, pores and so forth. Therefore, it is common to apply a barrier coating, e.g., an epoxy, to the outer surface of the oxide layer in order to increase its durability and corrosion resistance. In addition, it has been postulated that fluorinated polymer barrier coatings would provide additional corrosion resistance compared to current state-of-the art barrier coatings. However, fluorinated barrier coatings typically exhibit or have a relatively low surface free energy and thus provide less than desirable adhesion properties when a top coat is applied thereto. Therefore, an improved fluorinated barrier coating that affords good adhesion properties for a top coat applied thereto would be desirable.

### SUMMARY OF THE INVENTION

Bondable barrier coatings on oxidized metal surfaces are provided. The coatings are provided by treating an oxide layer with fluorine containing silane barrier compounds, or in the alternative with self-assembled monolayers (SAMs). In addition, the barrier coating is subjected to a plasma treatment with the plasma treated coating exhibiting barrier properties attributed to perfluorinated silanes, but with enhanced bonding/adhesion properties.

In some instances, the oxidized layer is an anodically grown oxide layer; however this is not required. Also, a fluorine containing silane barrier coating can have a silane attached to a fluorinated alkyl chain that has a reactive silicon end containing 1 to 3 leaving groups.

The alkyl chain can be any straight alkyl chain, for example a straight akyl chain having a C1-C30 length with an aliphatic hydrocarbon backbone. The alkyl chain can also have between 1 and 30 fluorinated carbon atoms and between 1 and 30 non-fluorinated carbon atoms, and a ratio of fluorinated carbon atoms to non-fluorinated carbon atoms between 30:0 and 1:30. Finally, the leaving groups of the silane can be any combination of a hydroxyl group, a methoxy group, an ethoxy group, a chloro group, an isopropyl group and so forth.

The SAM barrier coating can be any SAM assembly known to those skilled in the art with a head, tail and functional end group. In addition, the head group can include a thiol, silane, phosphonate, amine and so forth. Exemplary SAM precursors include 1H,1H,2H,2H-perfluorodecanethiol; 3,3,4,4,5,5,6,6,6-nonafluoro-1-hexanethiol; 1-hexadecanethiol; 1-decanethiol; 11-mercaptoundecyl trifluoroacetate; aminopropyltrimethoxysilane, aminopropyl triethoxysilane, mercaptopropyltriethoxysilane, octadecyltrichlorosilane, hexadecyltrichlorosilane, amongst others with different chain lengths and backbone or tail group chemistries.

A process for producing or manufacturing bondable fluorinated barrier coatings is also provided. The process includes applying a fluorine containing silane from a 1 mM to 1 M solution, preferably a 1 to 10 mM fluorinated silane containing solution, to an oxidized metal surface. In the alternative, a SAM is allowed to form on the oxidized metal surface. The fluorine containing silane solution is in contact with the oxidized metal surface for a time period between 1 second and 1 day, preferably between 10 minutes and 2 hours. In the event that a SAM is formed on the oxidized metal surface, the organic molecules that self-assemble into the SAMs are in contact with the surface for a time period between 1 second and 1 day, preferably between 10 minutes and 2 hours.

After the oxidized metal surface has been treated with the fluorine containing silane solution or the SAM precursor organic molecules, a perfluorinated surface or SAM with functional end groups, respectively, is/are present on the oxide layer and the treated surface is subjected to a plasma treatment. The plasma treatment oxidizes the perfluorinated surface or SAM functional end groups and thereby increases the adhesion properties thereof. Exposure of the perfluorinated surface to the plasma treatment can be for time period of between fractions of seconds to 30 minutes, preferably between 1 second and 5 minutes. Exposure of the SAMs functional end groups to the plasma treatment can be for a time period between fractions of seconds to 30 minutes, preferably between 1 second and 5 minutes. The atmospheric plasma treatment uses an inert plasma gas, a reactive plasma gas or a mixture thereof.

### BRIEF DESCRIPTION OF THE DRAWINGS

FIG. 1 is a schematic illustration of a prior art barrier coating system;

FIG. 2 is a schematic illustration of a surface having a high surface energy (A) and a surface having a low surface energy (B), (the liquid in this example is water);

FIGS. 3A-3D schematic illustration of a barrier coating system according to an embodiment of the present invention;

FIG. 4 is a schematic illustration of a process according to an embodiment of the present invention;

FIG. 5 is a schematic illustration of a self-assembled monolayer (SAM) structure; and

FIG. 6 is a graphical plot of electrochemical impedance for an anodically grown oxide layer on a AZ31B Mg alloy, an oxide layer after treatment with 1H,1H,2H,2H-perfluorodecyl triethoxy silane, and an oxide layer treated with 1H,1H,2H,2H-perfluorodecyl triethoxy silane after exposure of the silane-derived layer to an atmospheric plasma.

### DETAILED DESCRIPTION OF THE INVENTION

Fluorinated or self-assembled monolayer (SAM) barrier coatings that exhibit enhanced bonding/adhesion properties are provided. The coatings, in combination with an oxide layer, also provide excellent corrosion protection to an underlying metallic component. As such, the fluorinated or SAM barrier coatings have use as protective coatings for automotive components, aircraft components, and so forth. In some instances, the oxidized layer is an anodically grown oxide layer, however this is not required.

The fluorinated or SAM coatings are typically applied to a native oxide layer or an oxide layer that has been thermally and/or electrochemically grown on a metallic component. In addition, the fluorinated or SAM coatings have been treated with or exposed to a plasma that oxidizes a perfluorinated surface or a SAM functional end group, respectively, of the coating.

The metallic component can be made of any metal or alloy known to those skilled in the art that can grow an outer oxide scale, or in the alternative have an oxide scale applied thereto. For example, illustrative metals and alloys include iron, aluminum, magnesium, zinc, and copper. In addition, the plasma can be an atmospheric-pressure plasma and thus no reaction vessel is required to ensure a pressure level that is different that atmospheric pressure.

When a fluorinated coating is applied to the oxide layer, a perfluoroalkyl silane coating/layer is present and the perfluoralkyl silane is covalently bonded with the oxide layer and fills cracks, pores, etc. that are present on and in the oxide. Then, subjecting the perfluorakyl silane coating/layer to the plasma treatment partially oxidizes the coating surface and produces a chemical functionality at the air/perfluoroalkyl silane layer interface. It is appreciated that this partially oxidized surface can form chemical or hydrogen bonds with a topcoat applied thereto. In addition, the plasma is tailored to a sufficiently low energy such that the perfluoroalkyl silane coating/layer is surface modified and yet the coating still provides protection to the oxide layer and metallic component underneath.

The perfluoralkyl silane includes a silane molecule attached to an alkyl chain. Preferably, the alkyl chain is any C2-C30 straight alkyl chain with an aliphatic hydrocarbon backbone. The alkyl chain can also have between 1 to 30 fluorinated carbon atoms and between 0 to 30 non-fluorinated carbon atoms, and a ratio of fluorinated carbon atoms to non-fluorinated carbon atoms between 30:0 and 1:30. Finally, the silane molecule has 1-3 leaving groups that can be any combination of a hydroxyl group, a methoxy group, an ethoxy group, a chloro group, a isopropoxy group and so forth.

When a SAM coating is applied to the oxide layer, molecular assemblies spontaneously form on the oxide surface by absorption. Preferably the SAM coating has a functional head group with a strong affinity to the oxide surface and thus anchors the molecular assemblies thereto and fills cracks, pores, etc. that are present on and in the oxide. Exemplary functional head groups include thiols, silanes, phosphates and so forth.

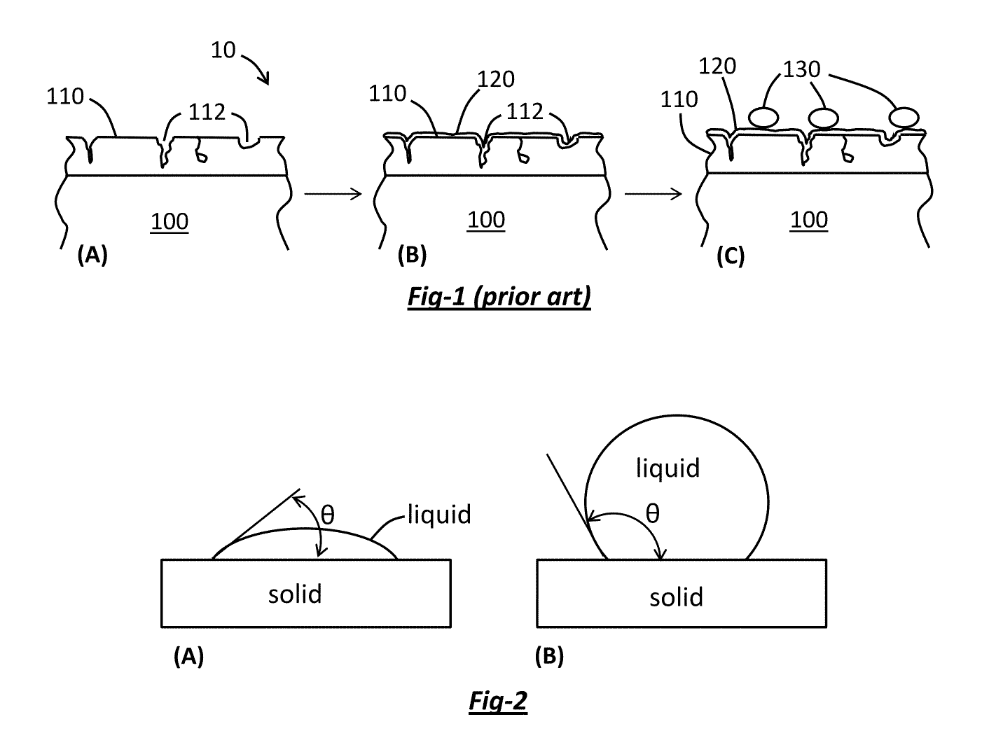

Turning to FIG. 1, a schematic illustration of a prior art fluorinated barrier coating system is shown generally at reference numeral 10. In particular, FIG. 1(A) illustrates a metallic component 100 with an outer oxide scale 110 extending across an outer surface of the component. FIG. 1(A) also illustrates that the oxide scale 110 has defects 112 such as microcracks, pores and so forth known to those skilled in the art.

FIG. 1(B) illustrates the metallic component 100 after a fluorinated or SAM coating 120 has been applied to an outer surface of the oxide scale 110. As shown by the figure, the coating 120 is generally conformal with the oxide scale 110 surface, fills or coats the defects 112 and thus enhances the protective properties, e.g. corrosion resistance, of the oxide scale 110. Stated differently, a combination of the oxide scale 110 and fluorinated or SAM coating 120 provides enhanced protection to the underlying metallic component 100.

However, and as illustrated in FIG. 1(C), prior-art fluorinated coating systems have hydrophobic properties and thus adhesion of a top coating material 130 to the outer surface of the fluorinated or SAM coating 120 is less than desirable. This is illustratively shown in the figure by the top coating material 130 being present as droplets on the surface of the coating 120.

One measure of the adhesion properties exhibited by a coating or surface is the contact angle between a drop of liquid placed thereon and the surface. For example, FIG. 2(A) illustrates a surface having a low contact angle θ with respect to a drop of water thereon and thus good adhesion properties, whereas FIG. 2(B) illustrates a surface having a high water contact angle θ and relatively poor adhesion properties.

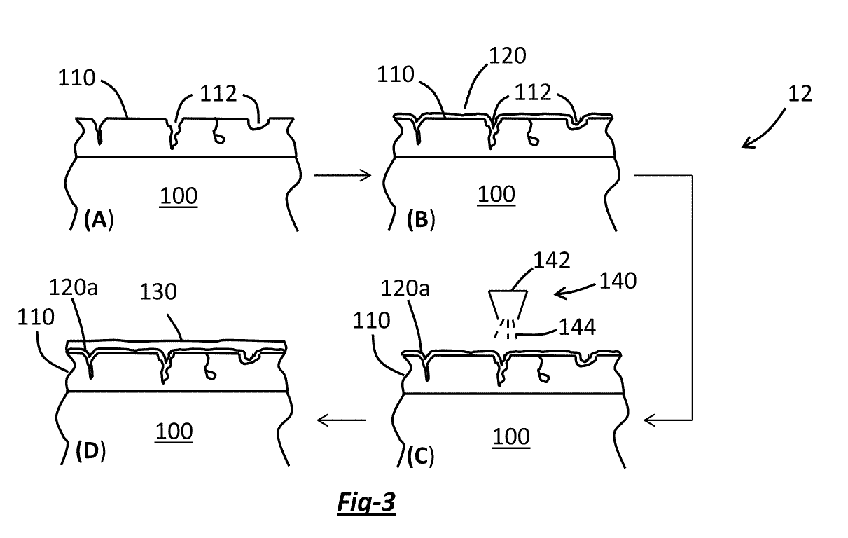

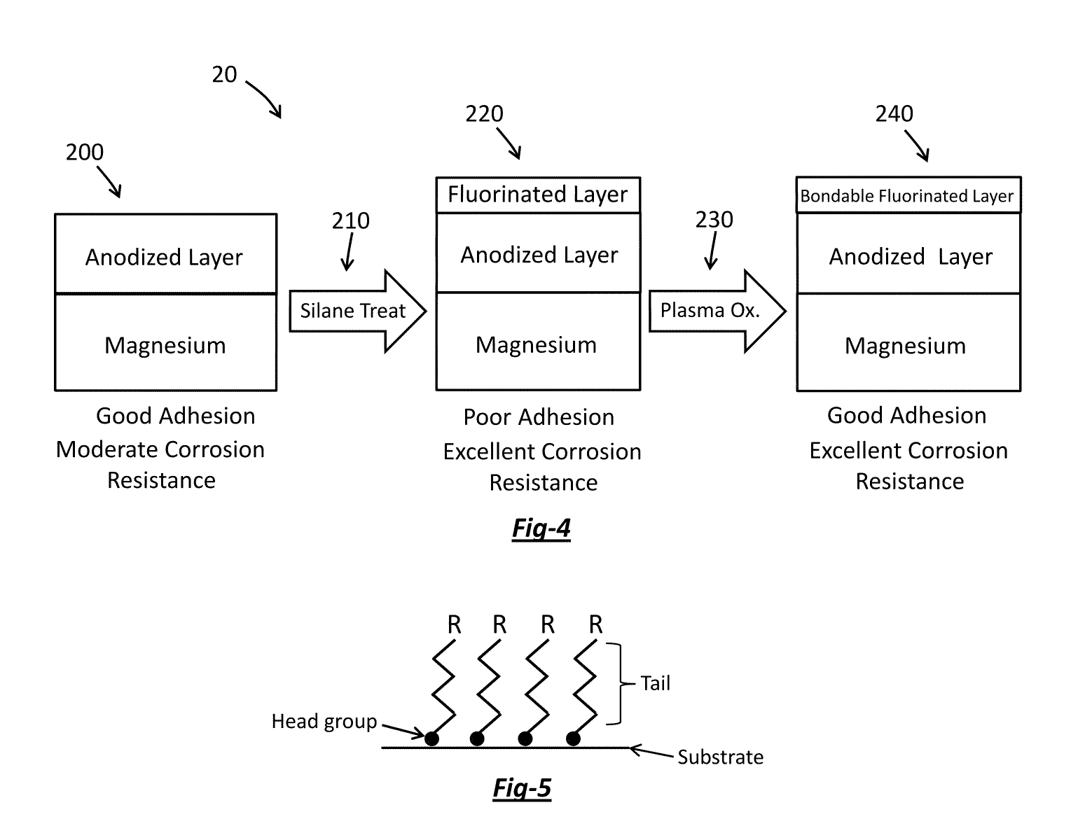

Turning now to FIG. 3, a schematic illustration of a fluorinated or SAM barrier coating system according to an embodiment of the present is shown generally at reference numeral 12. It is appreciated that FIGS. 3(A) and 3(B) are the same as FIGS. 1(A) and 1(B). However, FIG. 3(C) illustrates subjecting or treating the fluorinated or SAMs coating 120 to a plasma treatment 140. Also, the plasma treatment 140 is an atmospheric-pressure plasma treatment using a jet 142 that generates a plasma afterglow 144. The plasma afterglow 144 contains excited gas species of low energy that modify the surface of the fluorinated or SAMs coating 120 and produce a bondable fluorinated or SAMs coating 120a. As a result, the bondable fluorinated or SAMs coating 120a exhibits good-to-excellent adhesion properties as illustrated in FIG. 4(D) where the top coating material 130 has not “beaded” up on the coating 120a, but instead wets the surface and is present as a smooth coating.

For the purposes of the instant invention, the term “top coat” refers to any additional coating applied to an outer surface of the fluorinated coating, illustrative including a paint coating, a clear coat and so forth. For example and for illustrative purposes only, a top coat can include an oil-based paint layer, a latex-based paint layer, a poly-isocyanate containing clear coat layer, epoxy primers and so forth.

An illustrative example of a process for producing bondable fluorinated coatings on a magnesium component is shown in FIG. 4 at reference numeral 20. The process 20 includes providing a magnesium component with an anodized layer, i.e. an anodically grown oxide layer, at step 200. At step 210 the anodized layer is subjected to a fluorinated silane treatment which produces a fluorinated layer as illustrated at step 220. The fluorinated layer is then subjected to a plasma oxidation treatment at step 230 to provide a bondable anodized layer at step 240.

Also shown in FIG. 4 is a general rating of the adhesion in reference to a top coat and corrosion resistance of the outer surface of the magnesium component through the process. In particular, when the outer surface is the anodized layer, the surface has good adhesion and moderate corrosion resistance (step 200). After the fluorinated silane treatment, the outer surface has poor adhesion but excellent corrosion resistance (step 220). Then, the plasma treatment modifies the outer perfluorinated surface which results in a surface with good adhesion and excellent corrosion resistance (step 240).

The silane treatment at step 210 can include applying a 0.01 mM to 1 M fluorine containing silane solution, preferably a 1 to 10 mM fluorinated silane containing solution, to the oxidized metal surface. In addition, the fluorine containing silane solution can be left in contact with the oxidized metal surface for a time period between 1 second and 1 day, preferably between 10 minutes and 1 hour.

The oxide surface has electron donating nucleophilic groups that are capable of reacting with a silicon terminus of a perfluoralkyl silane molecule. As such, the anodized layer covalently bonds with a perfluoralkyl silane liquid applied thereto, the perfluoralkyl silane liquid sealing microcracks, pores and other defects. However, the perfluoralkyl silane layer has a polytetrafluoroethylene (PTFE)-like surface that has poor adhesion properties due to the low surface energy of the new air/layer interface and thus the need for the plasma treatment at step 230.

Exposure of the perfluorinated surface to the atmospheric-pressure plasma oxidation treatment at step 230 can be for time period of between fractions of second to 30 minutes, preferably between 1 second and 5 minutes. Also, the atmospheric-pressure plasma treatment uses an inert plasma gas, a reactive plasma gas or a mixture thereof.

The perfluoralkyl silane can have a general structure as shown below with X=0-30 and R1, R2 and R3 being any combination of H, Cl, OH, OMe, Oet, OlPr and similar leaving groups except for all H. In addition, the alkyl chain can have 1-30 carbon atoms that are fluorinated on 1-30 carbon atoms that are not fluorinated with a ratio of fluorinated carbon atoms to non-fluorinated carbon atoms between 30:0 and 1:30. In some instances X=2-8, while in other instances X=8-18, while in still other instances X=20-30.

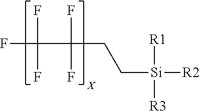

For example and for illustrative purposes only, silanes such as dimethoxy-methyl(3,3,3-trifluoropropyl)silane, 1H,1H,2H,2H-perfluorodecyltriethoxysilane, 1H,1H,2H,2H-perfluorododecyltrichlorosilane, 1H,1H,2H,2H-perfluorooctyltriethoxysilane, trichloro(1H,1H,2H,2H-perfluorooctyl)silane, trichloro(3,3,3-trifluoropropyl)silane and trimethoxy(3,3,3-trifluoropropyl)silane can be used. The SAMs can have a general structure as shown in FIG. 5.

In order to better teach the invention but not limit its scope in any way, one or more examples are provided below.

An AZ31B magnesium alloy sample having a nominal composition (wt %) within the range of 2.5-3.5 Al, 0.70-1.30 Zn, 0.20-1.0 Mn, with the reminder Mg and other incidental impurities was anodically oxidized to produce an external anodized layer using the TAGNITE® process. The anodized sample was then placed in 1 mM ethanolic solution of 1H,1H,2H,2H-perfluorodecyltriethoxy silane solution for 60 minutes. The solution was then exchanged for fresh 1 mM ethanolic solution of 1H,1H,2H,2H-perfluorodecyltriethoxy silane and the sample was allowed to soak for an additional 60 minutes. The sample was rinsed with ethanol, then De-ionized water, and dried using dry compressed air. The sample was then subjected to an atmospheric-pressure plasma treatment using a micro-pulsed power supply. The plasma gas was helium at a flow rate of 8000 sccm. Plasma power was 150 W and the time of plasma exposure was 5 seconds.

Contact angles of water on the surface of an as-oxidized sample, an as-coated sample and a coated plus plasma treated sample are shown in Table 1 below. As shown by the data, the bare tagnite sample had contact angles that were nearly wetting (˜20+/−9 degrees) whereas the fluorinated Tagnite surface was nearly super-hydrophobic with contact angles of 148+/−14 degrees. After plasma treatment, the fluorinated Tagnite sample was more hydrophilic with contact angles of 54+/−9 degrees.

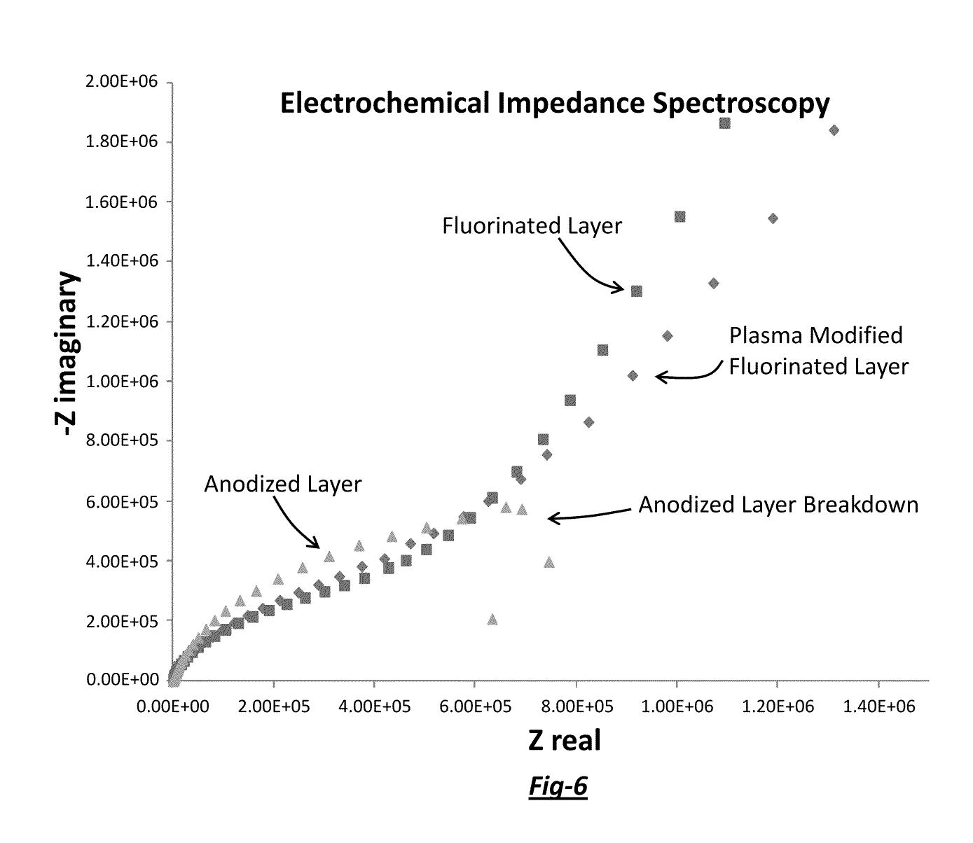

In addition to the above, a measure of the corrosion resistance exhibited by each of the samples obtained by electrochemical impedance spectroscopy (EIS) testing is shown in FIG. 6. As shown in the figure, the as-oxidized sample exhibited oxide layer breakdown, but the coated plus plasma treated sample exhibited similar behavior as the as-coated sample, i.e. no coating breakdown.

In addition to the above, the plasma treatment step is to ensure good adhesion of a subsequent topcoat. The plasma treatment does not degrade the barrier properties afforded by the fluorinated silane layer yet it does allow for good adhesion of a topcoat. Pull off test results using a HATE tester and 1″ aluminum dollies re shown in Table 1 below. Tagnite and treated Tagnite surfaces were coated with an epoxy primer. The adhesion results showed adhesive failure between fluorinated Tagnite and epoxy whereas the buried interface between the plasma treated fluorinated Tagnite and the control sample of bare Tagnite showed a mixed mode failure which typically happened at the dolly/epoxy interface. This result indicates that the plasma treatment enhances adhesion of a topcoat to the treated substrate.

TABLE 1

| Material/Surface => | Tagnite | Fluorinated Tagnite | Plasma Treated |
|---|---|---|---|
| Pull off Strength | 910 +/− 419 | 490 +/− 114 | 693 +/− 147 |
| (psi) | | | |

Changes and modifications to the teachings disclosed herein will be obvious to those skilled in the art and yet fall within the scope of the present invention. As such, the scope of the invention is defined by the claims and all equivalents thereof.

We claim:

1. A process for producing bondable fluorinated barrier coatings on oxidized metal surfaces, the process comprising:
providing an metal surface having an oxide layer;
treating the oxide layer with a barrier coating; and
applying a plasma treatment to the barrier coating.

2. The process of claim 1, wherein the barrier coating is selected from the group consisting of a fluorine containing barrier coating and a SAM barrier coating.

3. The process of claim 2, wherein the plasma treatment is an atmospheric or non atmospheric plasma treatment.

4. The process of claim 3, wherein the barrier coating is aliphatic, functionalized, or fluorine containing the silane barrier with the silane having a reactive silicon end containing 1 to 3 leaving groups attached to an alkyl chain.

5. The process of claim 4, wherein the 1 to 3 leaving groups are selected from the group consisting of an hydroxyl group, a methoxy group, an ethoxy group, a chloro group and a isopropoxy group.

6. The process of claim 5, wherein the alkyl chain has between 1-30 fluorinated carbon atoms and 1-30 non-fluorinated carbon atoms.

7. The process of claim 6, wherein the oxidized metal surface is soaked in a 0.01 mM to 1 M silane solution.

8. The process of claim 7, wherein the oxidized metal surface is soaked in a 1 mM to 10 mM silane solution.

9. The process of claim 8, wherein the atmospheric plasma treatment is applied to the treated oxide layer for time period between 1 second to 5 minutes.

10. The process of claim 9, wherein the atmospheric plasma treatment uses a plasma gas selected from an inert gas, a reactive gas and a combination thereof.

11. The process of claim 1, wherein the oxidized layer is an oxide layer grown on a substrate.

12. The process of claim 11, wherein the oxide layer is an anodically grown oxide layer.

13. A barrier coating system for an oxidized metal surface, said barrier coating system comprising:
a metal surface having an oxide layer thereon; and
a barrier coating on said oxide layer, said barrier coating having been exposed to an atmospheric plasma afterglow region.

14. The barrier coating system of claim 13, wherein said barrier coating is selected from the group consisting of a fluorine containing barrier coating and other SAM barrier coatings and combinations thereof.

15. The barrier coating system of claim 14, wherein said barrier coating is said fluorine containing barrier coating, said fluorine containing silane barrier coating having an oxidized surface from exposure to said atmospheric plasma afterglow region.

16. The barrier coating system of claim 15, wherein said fluorine containing silane barrier coating is a perfluoroalkyl or other aliphatic or functionalized silane coating.

17. The barrier coating system of claim 16, wherein said perfluoroalkyl silane or other silane coating has a reactive silicon end containing 1 to 3 leaving groups attached to an alkyl chain.

18. The barrier coating system of claim 17, wherein said 1 to 3 leaving groups are selected from the group consisting of an hydroxyl group, a methoxy group, an ethoxy group, a chloror group and a isoproxy group.

19. The barrier coating system of claim 18, wherein said alkyl chain has 1-30 fluorinated carbon atoms and 1-30 non-fluorinated carbon atoms.

20. The barrier coating system of claim 19, wherein said a ratio of fluorinated carbon atoms to non-fluorinated carbon atoms is between 30:0 and 1:30.
